(19) United States
(12) Patent Application Publication
(10) Pub. No.: US 2024/0231786 A1
(43) Pub. Date: Jul. 11, 2024

(54) PROVISION OF SOLUTION FOR ASSIGNMENT

(71) Applicant: RAKUTEN SYMPHONY KOREA, INC., Seoul (KR)

(72) Inventor: Youngju YANG

(73) Assignee: RAKUTEN SYMPHONY KOREA, INC., Seoul (KR)

(21) Appl. No.: 17/928,479

(22) PCT Filed: Sep. 26, 2022
(86) PCT No.: PCT/KR2022/014334

§ 371 Date: Nov. 29, 2022

(51) Int. Cl. G06F 8/61

(52) U.S. Cl. CPC G06F 8/61

(57) ABSTRACT

A device according to an aspect of the present disclosure may include a communication circuit configured to communicate with at least one external device, one or more processors, and one or more memories configured to store instructions which, when executed by the one or more processors, cause the one or more processors to perform a calculation. The one or more processors may be configured to acquire assignment information indicating a specific assignment requiring write of source code from a device of a first user among multiple users, match the assignment information with a second user among the multiple users, acquire solution information including specific source code wrote to solve the specific assignment from a device of the second user, and transfer the solution information to the device of the first user.

### TECHNICAL FIELD

The present disclosure relates to a technology for providing a solution for an assignment.

### BACKGROUND

In general, a developer may compile source code of a specific application by using an offline tool for development or an online complier, may confirm whether the application operates well, and may then generate the application. It is only after the developer uploads online an execution file generated as a result of compiling the source code that another user who wants to use the application can use the application based on the uploaded execution file.

However, if the process of generating or producing an application proceeds unilaterally from the developer to the user as described above, the user may be inconvenienced by the difficulty in informing the developer of a specific application specification or a specific assignment desired by the user.

Therefore, there has been an increasing demand for technology for effectively producing an application while solving user inconvenience.

### SUMMARY

It is a technical subject of the present disclosure to provide a solution for an assignment designated by a user.

It is another technical subject of the present disclosure to enable a user to acquire source code for solving a specific assignment from another user.

It is another technical subject of the present disclosure to enable a user to acquire source code for solving a specific assignment according to various source code languages.

It is another technical subject of the present disclosure to enable a user to acquire source code for solving a specific assignment which requires write of source code because private information is included.

As an aspect of the present disclosure, a device capable of providing a solution to an assignment may be provided. The device according to an aspect of the present disclosure may include a communication circuit configured to communicate with at least one external device, one or more processors, and one or more memories configured to store instructions which, when executed by the one or more processors, cause the one or more processors to perform a calculation. The one or more processors may be configured to acquire assignment information indicating a specific assignment requiring write of source code from a device of a first user among multiple users, match the assignment information with a second user among the multiple users, acquire solution information including specific source code wrote to solve the specific assignment from a device of the second user, and transfer the solution information to the device of the first user. The assignment information may include at least one predetermined condition for validating whether or not the specific assignment is solved.

As another aspect of the present disclosure, a device capable of providing a solution to an assignment may be provided. The device according to another aspect of the present disclosure may include a communication circuit configured to communicate with at least one external device, one or more processors, and one or more memories configured to store instructions which, when executed by the one or more processors, cause the one or more processors to perform a calculation. The one or memories may be configured to store at least one assignment-solution information pair including assignment information and at least one piece of solution information regarding the assignment information. The one or more processors may be configured to acquire assignment information indicating a specific assignment requiring write of source code from a device of a first user, determine solution information including specific source code wrote to solve the specific assignment, based on the at least one assignment-solution information pair stored in the memories, and transfer the solution information to the device of the first user. The assignment information may include at least one predetermined condition for validating whether or not the specific assignment is solved.

As another aspect of the present disclosure, a method capable of providing a solution to an assignment may be provided. The method according to another aspect of the present disclosure may be a method performed by an electronic device including a communication circuit configured to communicate with at least one external device, one or more processors, and one or more memories configured to store at least one instruction executed by the one or more processors, the method including: acquiring assignment information indicating a specific assignment requiring write of source code from a device of a first user among multiple users; matching the assignment information with a second user among the multiple users; acquiring solution information including specific source code wrote to solve the specific assignment from a device of the second user; and transferring the solution information to the device of the first user. The assignment information may include at least one predetermined condition for validating whether or not the specific assignment is solved.

### BRIEF DESCRIPTION OF DRAWINGS

The accompanying drawings, which are incorporated in and constitute a part of the specification, illustrate embodiments of the present disclosure.

FIG. 1 illustrates a system including a server, a user terminal, and a communication network according to an embodiment of the present disclosure.

FIG. 2 is a block diagram of a server according to an embodiment of the present disclosure.

FIG. 3 is a block diagram of a user terminal according to an embodiment of the present disclosure.

FIG. 4 is a flowchart illustrating operations in which a server acquires assignment information from a user and then provides solution information regarding a specific assignment indicated by the assignment information to the user according to an embodiment of the present disclosure.

FIG. 5 is a flowchart illustrating operations in which a server matches assignment information acquired from a user with at least one of multiple users according to an embodiment of the present disclosure.

FIG. 6 is a flowchart illustrating operations in which a server acquires solution information from each of two or more user terminals with regard to one piece of single assignment information according to an embodiment of the present disclosure.

FIG. 7 is a flowchart illustrating operations in which a server acquires assignment information from a user and then transfers solution information regarding a specific assignment indicated by the assignment information to the user according to another embodiment of the present disclosure.

### DETAILED DESCRIPTION

Various embodiments described herein are examples for clearly explaining the technical concept of the present disclosure, and are not intended to be limited to specific embodiments. The technical concept of the present disclosure encompasses various modifications, equivalents, and alternatives of respective embodiments described herein, as well as an embodiment selectively combined from all or part of each embodiment. In addition, the scope of the claims of the technical concept of the present disclosure is not limited by various embodiments presented below or detailed descriptions thereof.

Terms used herein, including technical or scientific terms, may have meanings that are generally understood by a person having ordinary knowledge in the an to which the present disclosure pertains, unless otherwise specified.

The expressions “include,” “may include,” “be provided with,” “may be provided with,” “have,” “may have,” and the like used herein mean that a feature (for example, function, operation, element, or the like) that becomes an object exists, and does not exclude the existence of other additional features. That is, such expressions should be understood as open-ended terms connoting the possibility of inclusion of other embodiments.

A singular expression used herein may include meanings of plurality, unless otherwise mentioned, and the same is applied to a singular expression recited in the claims.

The terms “first,” “second,” etc. used herein are used to identify a plurality of components of the same kind from one another unless otherwise mentioned, and are not intended to limit the order or importance of the relevant components.

The expressions “A, B, and C,” “A, B, or C,” “A, B, and/or C” or “at least one of A, B, and C,” “at least one of A, B, or C,” “at least one of A, B, and/or C,” “at least one selected from A, B, and C,” “at least one selected from A, B, or C,” “at least one selected from A, B, and/or C,” and the like used herein may denote each enumerated item or all possible combinations of enumerated items. For example, “at least one of A and B” may denote all of the following: (1) A, (2) at least one of A, (3) B, (4) at least one of B, (5) at least one of A and at least one of B, (6) at least one of A and B, (7) at least one of B and A, and (8) A and B.

The expression “based on” used herein is used to describe one or more factors that influence a decision, an action of judgment, or an operation described in a phrase or sentence including the relevant expression, and this expression does not exclude an additional factor influencing the decision, the action of judgment, or the operation.

When a certain component (for example, first component) is described herein as “coupled to” or “connected to” another component (for example, second component), this should be understood as having meaning that the certain component may be coupled or connected directly to the other component or that the certain component may be coupled or connected to the other component via a new intervening component (for example, third component).

The expression “configured to” used herein may have the meaning, depending on the context, of “set to,” “having the ability to,” “modified to,” “made to,” “capable of,” or the like. The expression is not limited to the meaning “specially designed in terms of hardware,” and a processor configured to perform a specific operation, for example, may denote a generic-purpose processor capable of performing the specific operation by executing software.

Hereinafter, various embodiments of the present disclosure will be described with reference to the accompanying drawings. In the accompanying drawings and descriptions with reference to the drawings, identical or substantially equivalent components may be indicated by identical reference numerals. Furthermore, in the following description of various embodiments, repeated descriptions of the identical or relevant components will be omitted. However, even if a description of a component is omitted, such a component is not intended to be excluded in an embodiment.

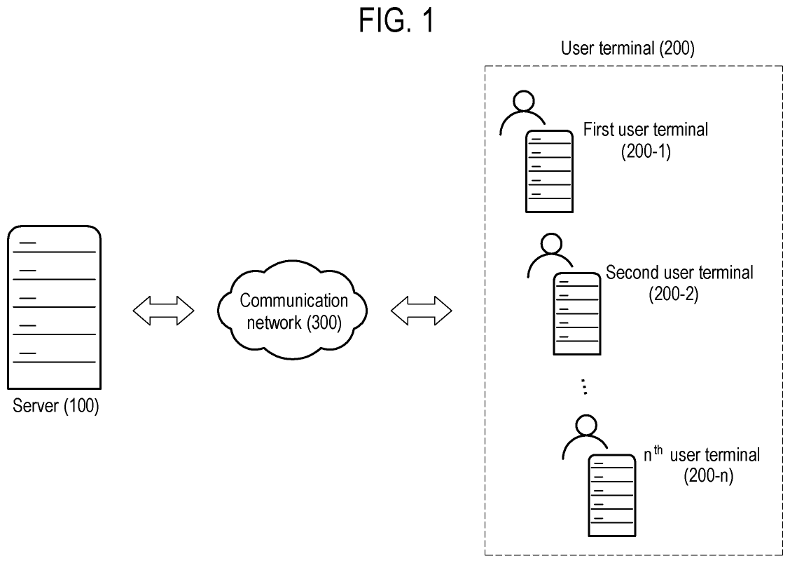

FIG. 1 illustrates a system including a server 100, a user terminal 200, and a communication network 300 according to an embodiment of the present disclosure. The server 100 and the user terminal 200 may exchange information with each other through the communication network 300 according to a solution providing technology disclosed herein.

The server 100 may be an electronic device of a service provider for providing or mediating a solution. The service provider may be an entity which operates a service for providing contents according to a content display technology disclosed herein. The server 100 may be an electronic device (for example, an application server, a proxy server, or a cloud server) which transmits information to the user terminal 200 connected thereto in a wired or wireless manner, or which provides a service thereto.

The user terminal 200 may refer to one or more user terminals or a set of two or more user terminals. In various embodiments of the present disclosure, when the user terminal 200 refers to a set of two or more user terminals, respective user terminals may be referred to as a first user terminal 200-1, a second user terminal 200-2, . . . , and an n^{th} user terminal (n is a natural number equal to or larger than 2).

The user terminal 200 may be the terminal of a user who uses the above-mentioned content providing service. The user terminal 200 may be, for example, at least one of a smartphone, a tablet computer, a personal computer (PC), a mobile phone, a personal digital assistant (PDA), an audio player, and a wearable device.

When describing the configuration or operation of a device in the present disclosure, the term “device” may be used to refer to a device that is being described, and the term “external device” may be used to refer to a device existing outside from the viewpoint of the device that is being described. For example, when the server 100 is described as a “device,” the user terminal 200 may be termed an “external device” from the viewpoint of the server 100. In addition, for example, when the user terminal 200 is described as a “device,” the server 100 may be termed an “external device” from the viewpoint of the user terminal 200. That is, the server 100 and the user terminal 20 may be respectively referred to as a “device” and an “external device” or as an “external device” and a “device” from the viewpoint of the operating agent. In the following description, “a device of a specific user (for example, device of first user)” may be used interchangeably with the expression “a user terminal of a specific user (for example, user terminal of first user)” or “a first user terminal (for example, first user's terminal).”

The communication network 300 may include either a wired communication network or a wireless communication network. The communication network 300 may enable data exchange between the server 100 and the user terminal 200. The wired communication network may include, for example, a communication network according to a scheme such as USB (Universal Serial Bus), HDMI (High Definition Multimedia Interface), RS-232 (Recommended Standard-232) or POTS (Plain Old Telephone Service). The wireless communication network may include, for example, a communication network according to a scheme such as eMBB (enhanced Mobile Broadband), URLLC (Ultra Reliable Low-Latency Communications). MMTC (Massive Machine Type Communications), LTE (Long-Term Evolution), LTE-A (LTE Advance), NR (New Radio), UMITS (Universal Mobile Telecommunications System), GSM (Global System for Mobile communications), CDMA (Code Division Multiple Access), WCDMA (Wideband CDMA), WiBro (Wireless Broadband), WiFi (Wireless Fidelity), Bluetooth, NFC (Near Field Communication), GPS (Global Positioning System), or GNSS (Global Navigation Satellite System). In the present disclosure, the communication network 300 is not limited to the above-mentioned examples, and may include without limitation various kinds of communication networks configured to enable data exchange between multiple agents or devices.

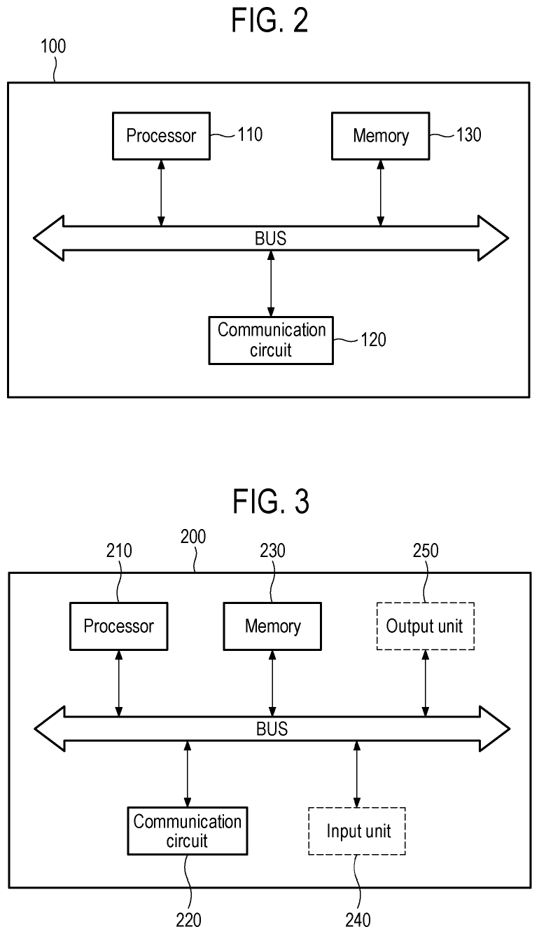

FIG. 2 is a block diagram of a server 10 according to an embodiment of the present disclosure. The server 100 may include one or more processors 110, a communication circuit 120, or a memory 130 as components thereof. In some embodiments, at least one of the components of the server 100 may be omitted, or another component may be added to the server 100. In some embodiments, in addition or in alternative to, some components may be integrated and implemented, or may be implemented as a single entity or multiple entities. At least some of the internal or external components of the server 100 may be connected to each other through a bus, a general purpose Input/Output (GPIO), a serial peripheral interface (SPI), or a mobile industry processor interface (MIPI), thereby exchanging data or signals.

One or more processors 110 may be referred to as a processor 110. The term “processor 110” may refer to one processor or a set of one or more processors unless explicitly mentioned otherwise. The processor 110 may drive software (for example, instructions, programs, and the like) so as to control at least one component of the server 100 connected to the processor 110. In addition, the processor 110 may perform various operations such as calculation, treatment, data generation, or processing. In addition, the processor 110 may load data or the like from the memory 130 or may store the same in the memory 130.

The communication circuit 120 may perform wireless or wired communication between the server 100 and another device (for example, user terminal 200 or another server). For example, the communication circuit 120 may perform wireless communication according to a scheme such as eMBB, URLLC, MMTC, LTE, LTE-A, NR, UMTS, GSM, CDMA, WCDMA, WiBro, WiFi, Bluetooth, NFC, GPS, or GNSS. In addition, the communication circuit 120 may perform wired communication according to a scheme such as USB (Universal Serial Bus), HDMI (High Definition Multimedia Interface), RS-232 (Recommended Standard-232), or POTS (Plain Old Telephone Service), for example.

The memory 130 may store various pieces of data. Data stored in the memory 130 may include software (for example, instructions, programs, and the like), which is acquired, processed, or used by at least one component of the server 100. The memory 130 may include a volatile or nonvolatile memory. The term “memory 130” may refer to one memory or a set of one or more memories unless explicitly mentioned otherwise. The expression “a set of instructions stored in the memory 130” or “a program stored in the memory 130” used herein may refer to an operating system for controlling resources of the server 100, an application, or middleware that provides various functions to the application such that the application can utilize resources of the server 100. In an embodiment, when the processor 110 performs a specific calculation, the memory 130 may store instructions which are performed by the processor 110, and which correspond to the specific calculation.

In an embodiment, the server 100 may transmit data resulting from a calculation by the processor 110, data received by the communication circuit 120, or data stored in the memory 130 to an external device. The external device may be a device for outputting (displaying or expressing) received data. The external device may be the user terminal 200, for example.

FIG. 3 is a block diagram of the user terminal 200 according to an embodiment of the present disclosure. The user terminal 200 may include one or more processors 210, a communication circuit 220, or a memory 230 as components thereof. In addition, the user terminal 200 may further include at least one of an input unit 240 or an output unit 250.

The processor 210 may drive software (for example, instructions, programs, and the like) so as to control at least one component of the user terminal 200 connected to the processor 210. In addition, the processor 210 may perform various operations such as calculation, treatment, data generation, or processing. In addition, the processor 210 may load data or the like from the memory 230 or may store the same in the memory 230.

The communication circuit 220 may perform wireless or wired communication between the user terminal 200 and another device (for example, server 100 or another user terminal). For example, the communication circuit 220 may perform wireless communication according to a scheme such as eMBB, URLLC, MMTC, LTE, LTE-A, NR, UMTS, GSM, CDMA, WCDMA, WiBro, WiFi, Bluetooth, NFC, GPS, or GNSS. In addition, the communication circuit 220 may perform wired communication according to a scheme such as USB, HDMI, RS-232, or POTS, for example.

The memory 230 may store various pieces of data. Data stored in the memory 230 may include software (for example, instructions, programs, and the like), which is acquired, processed, or used by at least one component of the user terminal 200. The memory 230 may include a volatile or nonvolatile memory. The term “memory 230” may refer to one memory or a set of one or more memories unless explicitly mentioned otherwise. The expression “a set of instructions stored in the memory 230” or “a program stored in the memory 230” used herein may refer to an operating system for controlling resources of the user terminal 200, an application, or middleware that provides various functions to the application such that the application can utilize resources of the user terminal 200. In an embodiment, when the processor 210 performs a specific calculation, the memory 230 may store instructions, which are performed by the processor 210 and which correspond to the specific calculation.

In an embodiment, the user terminal 200 may further include an input unit 240. The input unit 240 may be a component configured to transfer data received from the outside to at least one component included in the user terminal 200. For example, the input unit 240 may include a mouse, a keyboard, or a touch pad.

In an embodiment, the user terminal 200 may further include an output unit 250. The output unit 250 may display (output) information processed by the user terminal 200 or may transmit (send) the same to the outside. For example, the output unit 250 may visually display information processed by the user terminal 200. The output unit 250 may display user interface (UI) information, graphic user interface (GUI) information, or the like. In this case, the output unit 250 may include at least one of a liquid crystal display (LCD), a thin film transistor-liquid crystal display (TFT-LCD), an organic light-emitting diode (OLED), a flexible display, a 3D display, and an E-ink display. In addition, the output unit 250 may audibly display information processed by the user terminal 200, for example. The output unit 250 may display audio data following a specific audio file format (for example, MP3, FLAC, WAV, or the like) through a sound device. In this case, the output unit 250 may include at least one of a speaker, a headset, and a headphone.

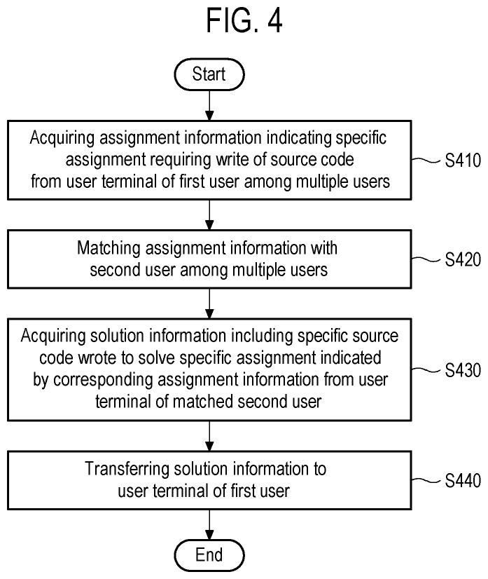

FIG. 4 is a flowchart illustrating operations in which the server 100 acquires assignment information from a user and then provides solution information regarding a specific assignment indicated by the assignment information to the user according to an embodiment of the present disclosure.

The processor 110 may acquire assignment information indicating a specific assignment, which requires write of source code, from a user terminal of a user (hereinafter, also referred to as “first user”) among multiple users (S410). In the present disclosure, an assignment may refer to a problem that can be solved by execution of source code by a computing device. In addition, the “source code” as used herein may refer to a set of characters or a document written according to the grammar of a specific language, prior to being converted or complied by the computing device. For example, types of the language of the source code may include Python, C, C++, and Java.

In addition, in the present disclosure, the assignment information may include at least one piece of information indicating a specific assignment. For example, the assignment information may include at least one of a description, the variable type of an input value and/or an output value, and a constraint on the input value and/or the output value. The description included in the assignment type may be a sentence that describes the assignment, and may be a sentence including the wording “a function for receiving two integers and outputting the sum of the two integers” or “a function for receiving two sentences and outputting a character string common to the two sentences.” The variable type included in the assignment information may be a value for defining the variable type of an input value or an output value, and may be “integer,” “float,” “character,” “string,” or the like, for example. The constraint included in the assignment information may be a condition that can be set according to the variable type of an input value or an output value. For example, when the variable type of an input value is “integer,” the constraint on the input value may be set as “above 0 and below 10000,” etc. and when the variable type of the input value is “string,” the constraint on the input value may be set as “string length is 10 or more,” etc. For example, assuming that specific assignment information is expressed in JSON (JavaScript Object Notation) format, the assignment information may be expressed, for example, as {“description”; “Do subtraction for given 2 integer numbers”, “first input value variable type”; “integer”, “second input value variable type”; “integer”, “output value variable type”; “integer”, “constraint on first input value”; “integer larger than 0 and smaller than 100000”, and “constraint on second input value”; “integer larger than 0 and smaller than 100000”}.

In an embodiment of the present disclosure, assignment information may further include at least one predetermined condition for validating whether a specific assignment is solved (hereinafter, also referred to as “validation condition”). According to an embodiment, the validation condition may be a condition configured such that it is determined, based on an input value and a predicted output value regarding the input value, whether or not the condition is satisfied. For example, it may be assumed that a specific assignment indicated by assignment information is “Generate a function indicating whether or not a string given as a first factor includes another string given as a second factor.” In this case, a validation condition may have “abcdefg” and “abc” configured as input values and may have “true” configured as a predicted output value related thereto. Another validation condition may have “abcdefg” and “ ” (that is, an empty string) configured as input values and may have “false” configured as a predicted output value related thereto. In addition, it may be assumed, for example, that a specific assignment indicated by assignment information is “Generate a function that returns the difference value between an integer given as a first factor and another integer given as a second factor.” In this case, a validation condition may have “10” and “4” configured as input values and may have “6” configured as a predicted output value related thereto. In addition, another validation condition included in at least one validation condition may have “10000” and “10000” configured as input values and may have “0” configured as a predicted output value related thereto. Some embodiments regarding validation conditions described above are only examples for describing the present disclosure, and do not limit the present disclosure.

In an embodiment according to the present disclosure, assignment information may further include language information indicating the language of the source code to be written. The language information indicating the language of the source code may include a string regarding the name of the language.

Next, the processor 110 may match the assignment information acquired in step S410 with a specific user (hereinafter, also referred to as “second user”) among multiple users (S420). The processor 110 may match at least one user among multiple users with assignment information. At least one user matched with the assignment information may be determined by the server 100 according to one or more predetermined schemes. In an embodiment, the user 100 may randomly select a user terminal from communicable user terminals 200 and may match the user of the selected user terminal with assignment information. In another embodiment, the server 100 may receive identification information (for example, user ID) of a specific user from a first user who has transferred assignment information and may match the user with assignment information. In another embodiment, the server 100 may transfer assignment information to the user terminal of a specific user and may match the user with assignment information based on a user input acquired from the user terminal of the user. Although it is described with reference to FIG. 4 that assignment information is matched with one user (second user) among multiple users, this description is only an example for describing the present disclosure, and assignment information of the present disclosure may be matched with two or more users.

Next, the processor 110 may acquire solution information including specific source code wrote to solve the specific assignment indicated by the assignment information from the user terminal of the user (that is, second user) matched with the assignment information in step S410 (S430).

In the present disclosure, the solution information may be information corresponding to specific assignment information. For example, the solution information may include source code wrote to solve a specific assignment indicated by the assignment information. The solution information may include a binary file or an execution file (for example, .exe file) acquired as a result of compiling the written source code. In addition, the solution information may further include, for example, at least one of information regarding the user who has wrote the source code, the computing environment that has validated the validation condition included in the assignment information, or the time at which the validation condition included in the assignment information has been validated. The description that assignment information and solution information “correspond,” as used herein, may be used to refer to a state in which one piece of assignment information remains matched with one piece of solution information. The server 100 may match specific assignment information and specific solution information, and may store the two pieces of matched information in a storage device (for example, memory 130). In the present disclosure, at least one piece of solution information may correspond to one piece of assignment information. That is, “assignment information” and “solution information” may have a one-to-many data relation. In an embodiment, when assignment information corresponds to multiple pieces of solution information, multiple source code included in the multiple pieces of solution information may be source code written in two or more different languages.

According to an embodiment of the present disclosure, specific source code included in solution information may satisfy all of at least one predetermined condition included in assignment information corresponding to the solution information. For example, it may be assumed that a specific assignment indicated by assignment information is “Generate a function that returns the difference value between an integer given as a first factor and another integer given as a second factor,” and that two validation conditions included in the assignment information are “input value: (10, 4), output value: 6” and “input value: (10000, 10000), output value: 0,” respectively. In this case, the source code of solution information corresponding to the assignment information may satisfy all of the two conditions.

According to an embodiment of the present disclosure, the server 100 may acquire at least one source code from the user terminal 200 and may confirm whether or not each of the at least one acquired source code satisfies all of the at least one validation condition. In addition, the server 100 may determine specific source code to be included in solution information from at least one source code acquired from the user terminal 200 based on the result of such confirmation. Specifically, in order to confirm whether or not each of the at least one source code acquired from a specific user terminal 200 satisfies a predetermined condition (that is, validation condition), the processor 110 may compile each source code, and may transfer the compiled result to the specific user terminal 200. If the at least one acquired source code has been written in two or more different languages, the processor 110 may perform compilation according to respective languages. The processor 110 may identify the compiled result with regard to each of the at least one source code acquired from the user, and may determine that source code that satisfies all of at least one validation condition is the specific source code to be included in the solution information.

Next, the processor 110 may transfer the solution information acquired in step S430 to the first user terminal (S440). Accordingly, the first user may transfer assignment information indicating a specific assignment to the server 100, and may acquire solution information for solving the specific assignment. In addition, the processor 110 may store data including assignment information and at least one piece of solution information regarding the assignment information (hereinafter, also referred to as “assignment-solution information pair”).

As described above, the first user may transfer (or upload) assignment information indicating a specific assignment, which requires write of source code, to the server 100, thereby acquiring the source code for solving the specific assignment from another user.

According to an embodiment of the present disclosure, the processor 110 may acquire evaluation information regarding solution information from the first user terminal after step S44) is performed. That is, the first user may acquire solution information regarding a specific assignment from the server 100 through the first user terminal, may generate evaluation information regarding evaluation of the quality or performance of the solution information, and may transfer the generated evaluation information to the server 100. The server 100 may store evaluation information acquired from the user terminal 200 in the memory 130. The server 100 may aggregate respective pieces of evaluation information regarding multiple users. It may be assumed, for example, that evaluation information includes evaluation scores included in a specific range such as “1 to 5” or “0 to 100.” The server 100 may then acquire an evaluation score regarding solution information from the user terminal 2001, and may store the evaluation score so as to correspond to the user who has wrote the source code included in the solution information. The server 100 may calculate the average value of one or more evaluation scores stored to correspond to respective users (hereinafter, also referred to as “average evaluation score”).

According to an embodiment of the present disclosure, the processor 110 may transfer category information regarding a specific assignment indicted by assignment information to the user terminal of at least one user among multiple users. As used herein, “category information” refers to information corresponding to each assignment included in multiple assignments, as a result of classifying the multiple assignments according to a predetermined reference, and may include at least one string indicating a specific group to which a specific assignment belongs. Hereinafter, the expression “category information regarding a specific assignment” may be used interchangeably with the expression “category information corresponding to a specific assignment” or “category information of a specific assignment.” It may be assumed, for example, that multiple assignments are related to “four basic arithmetic operations.” Among the multiple assignments, the first group of assignments may be classified as “addition,” the second group of assignments may be classified as “subtraction,” the third group of assignments may be classified as “multiplication,” and the fourth group of assignments may be classified as “division.” In addition, a specific assignment among the multiple assignments may correspond to category information including a string indicating one of “four basic arithmetic operations/addition,” “four basic arithmetic operations/subtraction,” “four basic arithmetic operations/multiplication”, and “four basic arithmetic operations/division.” As another example, it may be assumed that multiple assignments are related to “homework given to department B in college A.” Among the multiple assignments, the first group of assignments may be classified as “freshman course,” the second group of assignments may be classified as “sophomore course,” the third group of assignments may be classified as “junior course,” and the fourth group of assignments may be classified as “senior course.” In addition, a specific assignment among the multiple assignments may correspond to category information including a string indicating one of “homework given to department B in college A/freshman course,” “homework given to department B in college A/sophomore course,” “homework given to department B in college A/junior course,” and “homework given to department B in college A/senior course.” In addition, category information of a specific assignment may include a string indicating two or more different groups. For example, a specific assignment may correspond to category information including a string indicating different groups such as “programming language/Python” and “four basic arithmetic operations/subtraction.”

According to an embodiment of the present disclosure, the server 100 may acquire category information regarding a specific assignment from the first user terminal. In other words, the first user may transfer category information to the server 100 through the input unit 240 of the user terminal, and the server 100 may thus acquire category information regarding a specific assignment indicated by assignment information.

According to another embodiment of the present disclosure, the server 100 may determine category information regarding a specific assignment by performing a predetermined calculation based on at least one piece of previously acquired assignment information. In an embodiment, the server 100 may compare a keyword set of assignment information, the category information of which is to be determined (hereinafter, also referred to as “target assignment information”) with a keyword set of at least one piece of previously acquired assignment information, and may determine category information of a specific assignment indicated by the target assignment information according to the result of comparison. The at least one piece of previously acquired assignment information or the keyword set of each of the at least one piece of previously acquired assignment information may be stored in the memory 130.

As used herein, a “keyword set” may refer to a set or group of keywords extracted by applying a keyword extraction method (for example, TextRank, TF-IDF, word embedding-based keyword extraction method, artificial neural network-based natural language processing method, or the like) to a document or a set of characters. For example, a keyword set extracted according to a keyword extraction method applied to a sentence “Make a function for receiving two variables and returning their difference value” may be [“variable”, “two”, “difference value”, “function”].

The server 100 may determine category information of a specific assignment indicated by target assignment information on the basis of the similarity between the keyword set of the target assignment information and the keyword set of each of at least one piece of previously acquired assignment information. The similarity between the keyword sets may be confirmed according to whether the two keyword sets include a threshold number of identical keywords or more, for example. Specifically, assuming that the keyword set extracted from first assignment information is [“A”, “B”, “C”, “D”], the keyword set extracted from second assignment information is [“A”, “B”, “C”, “E”], and the threshold number of keywords for confirming similarity between keyword sets is three, the keyword set of the first assignment information and the keyword set of the second assignment information include three identical keywords (that is, “A,” “B,” “C”), the number of which is equal to or larger than the threshold number (three). Accordingly, the keyword set of the first assignment information and the keyword set of the second assignment information may be deemed similar to each other. When the first assignment information and the keyword set of the second assignment information are determined to be similar to each other, the server 100 may determine, based on the category information of one of the first assignment information and the second assignment information, category information of the other. For example, assuming that first assignment information is target assignment information and second assignment information refers to one piece of previously acquired assignment information, the server 100 may configure or generate category information of the first assignment information by using category information of the second assignment information.

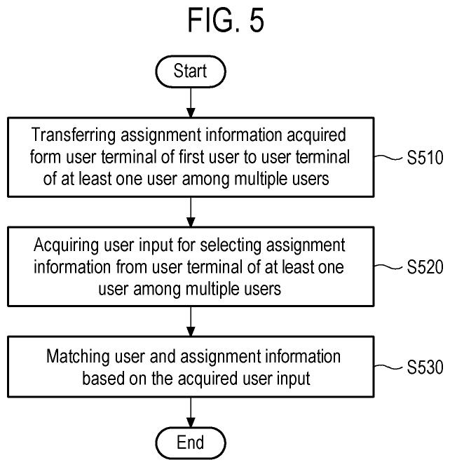

FIG. 5 is a flowchart illustrating operations in which the server 100 matches assignment information acquired from a user with at least one of multiple users according to an embodiment of the present disclosure. Respective steps of the matching method described with reference to FIG. 5 may be included in step S420 in FIG. 4.

The processor 110 may transfer assignment information acquired from the first user terminal to the user terminal of at least one user among multiple users (S510). In an embodiment in which the processor 110 is to transfer assignment information to some users, the processor 110 may transfer assignment information to all user terminals 200 capable of communicating with the server 100, thereby transferring assignment information to the user terminal of at least one user among the multiple users. In another embodiment, the processor 110 may determine multiple users to which assignment information is to be transferred, according to a scheme, and may transfer assignment information to the multiple determined users.

In an embodiment for determining multiple users to whom assignment information is to be transferred according to the present disclosure, the multiple users may satisfy a condition regarding reward money. In this case, the processor 110 may acquire reward information indicating reward money from the first user terminal. The reward money according to the present disclosure may refer to an amount of money that may be given to a user who has solved a specific assignment indicated by assignment information. The reward money may be determined by the first user in view of a degree of difficulty in solving the assignment indicated by assignment information, the necessary time, and the like. The server 100 may store a condition regarding reward money of each of the multiple users in the memory 130. It will be assumed, for example, that reward information transferred from the first user together with assignment information indicates reward money “$100.” Multiple users to whom the server 100 is to transfer assignment information acquired from the first user may then have a condition regarding reward money, which allows “$100” (for example, “reward money of $20 or more” or “reward money of $100 or more”) among all users.

In an embodiment for determining multiple users to which assignment information is to be transferred according to the present disclosure, the multiple users may be developers capable of using the language indicated by language information included in the assignment information. In this case, the assignment information may include language information indicating the language of source code, and multiple users may register the type of languages they can use in the server 100. It will be assumed, for example, that the language of the source code indicated by language information included in assignment information transferred from the first user is “Python.” Multiple users to whom the server 100 is to transfer assignment information acquired from the first user may then be those using languages, including “Python,” among all users.

In an embodiment for determining multiple users to whom assignment information is to be transferred according to the present disclosure, the multiple users may be users satisfying a condition regarding evaluation information. In this case, the processor 110 may acquire a condition regarding evaluation information from the first user terminal. It may be assumed, for example, that the condition regarding evaluation information is expressed as “average point of 4 or higher (full score is five)” or “average score of 90 or higher (full score is 100).” The server 100 may then determine multiple users satisfying the condition regarding evaluation information based on the average score of each of all users stored in the memory 130.

Next, the processor 110 may acquire a user input for selecting assignment information from the user terminal of at least one user among multiple users (S520). It will be assumed in the following description of an embodiment with reference to FIG. 5 that a user input has been acquired from a single user among multiple users, and the single user may be referred to as a second user for convenience. For example, the processor 110 may acquire a user input for selecting assignment information from the second user terminal. The user may select, through the input unit 240, specific assignment information from one or more pieces of assignment information displayed through the output unit 250 of the user terminal 200, and may transfer a user input regarding the specific selected assignment information to the server 100. That is, the server 100 may acquire a user input for selecting specific assignment information from the user terminal 200.

Next, the processor 110 may match a user and the assignment information based on the acquired user input (S530). When the assignment information is matched with at least one user, the processor 110 may stop an additional matching operation related to the assignment information. The processor 110 may store the matching result of the assignment information and the user in the memory 130.

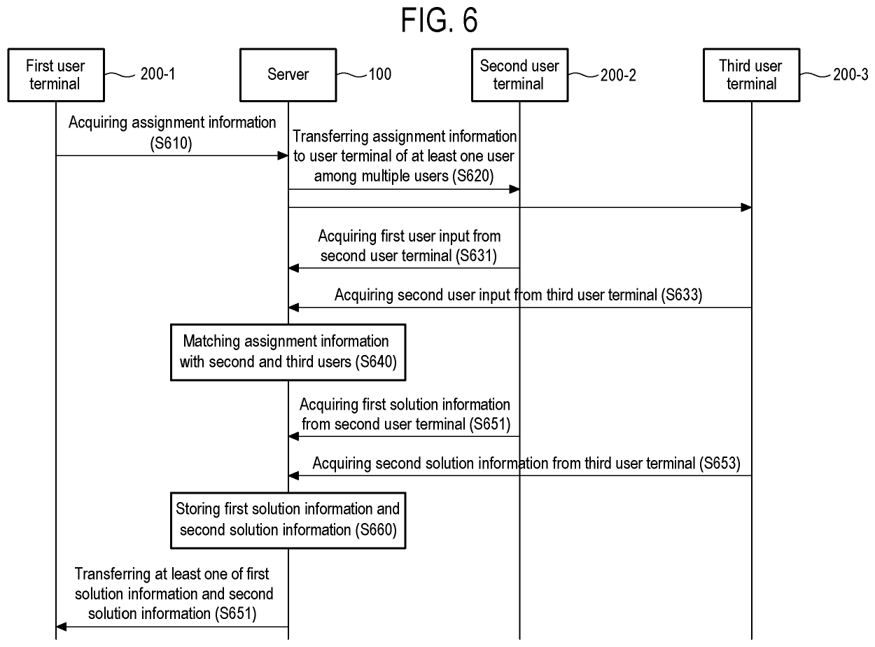

FIG. 6 is a flowchart illustrating operations in which the server 100 acquires solution information from each of two or more user terminals with regard to one piece of single assignment information according to an embodiment of the present disclosure. It will be assumed in the following description of an embodiment with reference to FIG. 6 that solution information has been acquired from each of two different users among multiple users, and the two users may be referred to as second and third users, respectively, for convenience.

The server 100 may acquire assignment information indicating a specific assignment from a first user terminal 200-1 (S610). After receiving the assignment information, the server 100 may transfer the assignment information to the user terminal of at least one user among multiple users (S620). For example, the server 100 may transfer the assignment information to the user terminal (second user terminal 200-2) of the second user among the multiple users and to the user terminal (third user terminal 200-3) of the third user, respectively. The server 100 may then acquire a first user input from the second user terminal 200-2 (S631), and may acquire a second user input from the third user terminal 200-3 (S633). The server 100 may thus match the assignment information with the second and third users (S640). The above-mentioned steps S610 to S640 may be performed by the server 100 identically or similarly to step S410 and S420 described above with reference to FIG. 4 and respective steps described above with reference to FIG. 5.

Next, the server 100 may acquire first solution information from the second user terminal 200-2 (S651). In addition, the server 100 may acquire second solution information from the third user terminal 200-3 (S653).

In an embodiment according to the present disclosure, when specific assignment information includes language information indicating the language of source code, solution information corresponding to the assignment information may include source code written in the language indicated by the language information. For example, the language indicated by the language information and the language of the source code included in the solution information may both be Python. In addition, even if specific assignment information includes language information indicating the language of source code, solution information corresponding to the assignment information may include source code written in a language different from the language indicated by the language information. For example, the language indicated by the language information may be Python, and the language of the source code included in the solution information may be C++. It will be assumed in the following description of an embodiment with reference to FIG. 6 that, for convenience of description, first solution information includes source code written in the language indicated by language information included in assignment information, and second solution information includes source code written in a language different from the language indicated by the language information included in the assignment information.

The server 100 may store the first solution information and the second solution information in the memory 130 (S660). The server 100 may store at least one piece of solution information regarding specific assignment information in the above-mentioned “assignment-solution information pair” type in the memory 130 such that, if assignment information identical or similar to the specific assignment information is later acquired, solution information corresponding to the acquired assignment information may be returned to the user without additionally acquiring solution information.

The server 100 may transfer at least one of the first solution information and the second solution information to the first user terminal 200-1 (S670). In an embodiment, when assignment information includes no language information, the processor 110 may transfer both the first solution information and the second solution information to the first user terminal 200-1. In another embodiment, when assignment information includes language information indicating the language of source code, the processor 110 may transfer the first solution information to the first user terminal 200-1. In another embodiment, even when assignment information includes language information indicating the language of source code, the processor 110 may transfer both the first solution information and the second solution information to the first user terminal 200-1. If the server 100 provides source code written in different languages to a user in some embodiments described above, the user may acquire source code for solving a desired assignment according to various languages.

According to an embodiment of the present disclosure, the server 100 may acquire, from the user terminal of a user (for example, first user) to which assignment information is transferred, private information necessary to solve a specific assignment indicated by the assignment information, and may transfer the private information to the user terminal of a user (for example, second user) matched with the assignment information. The private information may include, for example, source code managed by the first user in a private type, the Internet address that can be used to access the source code, or the like. Accordingly, the user matched with the assignment information may write specific source code for solving the specific assignment indicated by the assignment information, including the private source code.

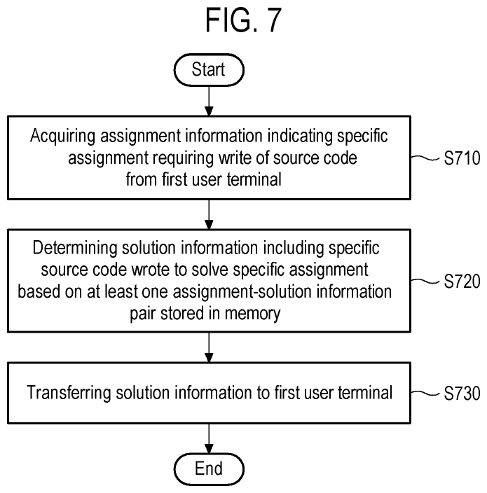

FIG. 7 is a flowchart illustrating operations in which the server 100 acquires assignment information from a user and then transfers solution information regarding a specific assignment indicated by the assignment information to the user according to another embodiment of the present disclosure. The processor 110 may acquire assignment information indicating a specific assignment, which requires write of source code, from the first user terminal (S710). Step S710 may be performed by the server 100 identically or similarly to step S410 described above with reference to FIG. 4.

Next, the processor 110 may determine solution information including specific source code wrote to solve a specific assignment based on at least one assignment-solution information pair stored in the memory 130 (S720). Specifically, the processor 110 may compare assignment information, which is acquired from a user and requires solution information (hereinafter, also referred to as “target assignment information”), and assignment information of one or more assignment-solution information pairs stored in the memory 130 (hereinafter, also referred to as “reference assignment information”), thereby determining solution information for solving the specific assignment indicated by the target assignment information. For example, the processor 110 may compare the description included in the target assignment information with the description included in at least one piece of reference assignment information such that, when the two descriptions are identical or are similar to a specific degree or more, the processor 110 may determine that solution information of the assignment-solution information pair including the reference assignment information is the solution information for solving the specific assignment indicated by the target assignment information. As another embodiment, the processor 110 may compare the keyword set of the target assignment information with the keyword set of the reference assignment information such that, when the keyword sets are similar to each other, the processor 110 may determine that solution information of the assignment-solution information pair including the reference assignment information is the solution information for solving the specific assignment indicated by the target assignment information. The method for calculating a degree of similarity between respective keyword sets of multiple pieces of assignment information has already been described above, and repeated descriptions thereof will be omitted herein.

Next, the processor 110 may transfer the determined solution information to the first user terminal (S730). An embodiment of the present disclosure described with reference to FIG. 7 is advantageous as follows: the server 100 matches at least one piece of solution information with previously acquired assignment information and stores the same as an assignment-solution information pair in the memory 130 such that, if assignment information newly acquired from a specific user is identical or similar to previously acquired assignment information, solution information can be instantly provided to the specific user without waiting for another user to solve the same.

According to various embodiments of the present disclosure, a user may acquire source code for solving a specific assignment which requires write of source code from another user.

According to various embodiments of the present disclosure, a user may acquire source code for solving a specific assignment which requires write of source code according to various source code languages.

According to various embodiments of the present disclosure, a user may acquire source code for solving a specific assignment which requires write of source code because private information is included.

Methods according to the present disclosure may be methods implemented by a computer. Although respective operations of the corresponding methods have been illustrated and described in a specific order in the present disclosure, respective operations may not only be performed successively, but also be performed in any combinable order according to the present disclosure. In an embodiment, at least some operations may be performed in a parallel, repetitive, or heuristic manner. The present disclosure does not exclude changes or modifications to the corresponding methods. In an embodiment, at least some operations may be omitted, or other operations may be added.

Various embodiments of the present disclosure may be implemented as software recorded in a machine-readable recording medium which can be mad by a machine. The software may be software for implementing various embodiments of the present disclosure described above. The software may be inferred from various embodiments of the present disclosure by programmers in the art to which the present disclosure pertains. For example, the software may be a machine-readable command (for example, code or code segment) or program. The machine refers to a device capable of operating according to a command retrieved from a recording medium, and may be a computer, for example. In an embodiment, the machine may be an unmanned terminal or a server according to embodiments of the present disclosure. In an embodiment, the processor of the machine may execute a retrieved command such that components of the device perform a function corresponding to the command. The recording medium may refer to any kind of recording medium which can be read by a machine, and in which data is stored. Examples of the recording medium may include a ROM, RAM, CD-ROM, magnetic tape, floppy disk, optical data storage device, and the like. In an embodiment, the recording medium may be implemented to be distributed to computer systems or the like, which are connected through a network. The software may be distributed and stored in computer systems or the like, and then executed. The recording medium may be a non-transitory recording medium. The non-transitory recording medium refers to a tangible medium which exists regardless of whether data is stored semi-permanently or temporarily, and does not include a signal that is transmitted in a transitory manner.

Although the technical concept of the present disclosure has been described by various embodiments, the technical concept of the present disclosure includes various substitutions, modifications, and changes which can be made without departing from the scope of the present disclosure which can be understood by those skilled in the art to which the present disclosure pertains. In addition, it should be noted that that such substitutions, modifications, and changes are intended to fall within the scope of the appended claims. Embodiments according to the present disclosure may be combined with each other. Respective embodiments may be variously combined according to the number of cases, and embodiments obtained through combinations also fall within the scope of the present disclosure.

Hereinafter, various embodiments of the present disclosure will be described additionally.

### [Supplementary Note 1]

An electronic device including:
a communication circuit configured to communicate with at least one external device;
one or more processors; and
one or more memories configured to store instructions which, when executed by the one or more processors, cause the one or more processors to perform a calculation.
wherein the one or more processors are configured to:
   acquire assignment information indicating a specific assignment requiring write of source code from a device of a first user among multiple users,
   match the assignment information with a second user among the multiple users,
   acquire solution information including specific source code wrote to solve the specific assignment from a device of the second user, and
   transfer the solution information to the device of the first user, and
wherein the assignment information includes at least one predetermined condition for validating whether or not the specific assignment is solved.

### [Supplementary Note 2]

The electronic device of Supplementary Note 1,
wherein the predetermine condition is a condition for which whether or not the condition is satisfied is determined based on an input value and a predicted output value regarding the input value.

### [Supplementary Note 3]

The electronic device of Supplementary Note 1 or 2,
wherein the specific source code is source code satisfying all of the at least one predetermined condition.

### [Supplementary Note 4]

The electronic device of Supplementary Note 3,
wherein the one or more processors are configured to:
acquire at least one source code from the device of the second user,
confirm, with regard to each of the at least one source code, whether or not all of the at least one predetermined condition is satisfied, and
determine the specific source code among the at least one source code, based on the confirmation result.

### [Supplementary Note 5]

The electronic device of one of Supplementary Notes 1 to 4,
wherein the one or more processors are configured to transfer category information regarding the specific assignment to a device of at least one user among the multiple users.

### [Supplementary Note 6]

The electronic device of Supplementary Note 5,
wherein the category information is determined by a predetermined calculation performed by the one or more processors based on at least one piece of previously acquired assignment information.

### [Supplementary Note 7]

The electronic device of one of Supplementary Notes 1 to 6,
wherein the one or more processors are configured to:
transfer the assignment information to a device of at least one user among the multiple users,
acquire a user input that selects the assignment information from the device of the second user, and
match the second user with the assignment information according to the user input.

### [Supplementary Note 8]

The electronic device of Supplementary Note 7,
wherein the one or more processors are configured to acquire reward information indicating reward money from the device of the first user, and
the at least one user is a user satisfying a condition regarding the reward money.

### [Supplementary Note 9]

The electronic device of one of Supplementary Notes 1 to 8,
wherein the assignment information further includes language information indicating a language of a source code to be written, and
the specific source code is a source code written in the language indicated by the language information.

### [Supplementary Note 10]

The electronic device of one of Supplementary Notes 1 to 8,
wherein the assignment information further includes language information indicating a language of a source code to be written, and
the one or more processors are configured to acquire solution information including a specific source code written in a language different from the language indicated by the language information from a device of a third user among the multiple users.

### [Supplementary Note 11]

The electronic device of one of Supplementary Notes 1 to 10,
wherein the one or more processors are configured to:
acquire private information required to solve the specific assignment from the device of the first user, and
transfer the private information to the device of the second user.

### [Supplementary Note 12]

An electronic device including:
a communication circuit configured to communicate with at least one external device;
one or more processors; and
one or more memories configured to store instructions which, when executed by the one or more processors, cause the one or more processors to perform a calculation,
wherein the one or memories are configured to store at least one assignment-solution information pair including assignment information and at least one piece of solution information regarding the assignment information,
wherein the one or more processors are configured to:
   acquire assignment information indicating a specific assignment requiring write of source code from a device of a first user,
   determine solution information including specific source code wrote to solve the specific assignment, based on the at least one assignment-solution information pair stored in the memories, and
   transfer the solution information to the device of the first user, and
wherein the assignment information includes at least one predetermined condition for validating whether or not the specific assignment is solved.

### [Supplementary Note 13]

A method performed by an electronic device including a communication circuit configured to communicate with at least one external device, one or more processors, and one or more memories configured to store at least one instruction executed by the one or more processors, the method including:
acquiring assignment information indicating a specific assignment requiring write of source code from a device of a first user among multiple users;
matching the assignment information with a second user among the multiple users;
acquiring solution information including specific source code wrote to solve the specific assignment from a device of the second user; and
transferring the solution information to the device of the first user,
wherein the assignment information includes at least one predetermined condition for validating whether or not the specific assignment is solved.

### [Supplementary Note 14]

The method of Supplementary Note 13,
wherein the specific source code is source code satisfying all of the at least one predetermined condition.

### [Supplementary Note 15]

The method of Supplementary Note 14, further including:
acquiring at least one source code from the device of the second user;
confirming, with regard to each of the at least one source code, whether or not all of the at least one predetermined condition is satisfied; and
determining the specific source code among the at least one source code based on the confirmation result.

### [Supplementary Note 16]

The method of one of Supplementary Notes 13 to 15,
further including transferring category information regarding the specific assignment to a device of at least one user among the multiple users.

### [Supplementary Note 17]

The method of one of Supplementary Notes 13 to 16,
wherein the matching the assignment information with the second user includes:
transferring the assignment information to a device of at least one user among the multiple users;
acquiring a user input that selects the assignment information from the device of the second user; and
matching the second user with the assignment information according to the user input.

### [Supplementary Note 18]

The method of one of Supplementary Notes 13 to 17,
wherein the assignment information further includes language information indicating a language of source code to be written, and
the specific source code is source code written in the language indicated by the language information.

### [Supplementary Note 19]

The method of one of Supplementary Notes 13 to 17,
wherein the assignment information further includes language information indicating a language of a source code to be written, and
wherein the method further includes acquiring solution information including a specific source code written in a language different from the language indicated by the language information from a device of a third user among the multiple users.

### [Supplementary Note 20]

The method of one of Supplementary Notes 13 to 19, further including:
acquiring private information required to solve the specific assignment from the device of the first user; and
transferring the private information to the device of the second user.

Although technical features of the present disclosure have been described by some embodiments and the accompanying drawings, various substitutions, modifications, and changes may be made without departing from the scope of the present disclosure which can be understood by those skilled in the art to which the present disclosure pertains. In addition, such substitutions, modifications, and changes fall within the scope of the appended claims.

What is claimed is:

1. An electronic device comprising:
a communication circuit configured to communicate with at least one external device;
one or more processors; and
one or more memories configured to store instructions which, when executed by the one or more processors, cause the one or more processors to perform a calculation,
wherein the one or more processors are configured to:
acquire assignment information indicating a specific assignment requiring write of source code from a device of a first user among multiple users,
match the assignment information with a second user among the multiple users,
acquire solution information including specific source code wrote to solve the specific assignment from a device of the second user, and
transfer the solution information to the device of the first user, and
wherein the assignment information includes at least one predetermined condition for validating whether or not the specific assignment is solved.

2. The electronic device of claim 1, wherein the predetermined condition is a condition for which whether or not the condition is satisfied is determined based on an input value and a predicted output value regarding the input value.

3. The electronic device of claim 1, wherein the specific source code is source code satisfying all of the at least one predetermined condition.

4. The electronic device of claim 3, wherein the one or more processors are configured to:
acquire at least one source code from the device of the second user,
confirm, with regard to each of the at least one source code, whether or not all of the at least one predetermined condition is satisfied, and
determine the specific source code among the at least one source code, based on the confirmation result.

5. The electronic device of claim 1, wherein the one or more processors are configured to transfer category information regarding the specific assignment to a device of at least one user among the multiple users.

6. The electronic device of claim 5, wherein the category information is determined by a predetermined calculation performed by the one or more processors based on at least one piece of previously acquired assignment information.

7. The electronic device of claim 1, wherein the one or more processors are configured to:
transfer the assignment information to a device of at least one user among the multiple users,
acquire a user input that selects the assignment information from the device of the second user, and
match the second user with the assignment information according to the user input.

8. The electronic device of claim 7, wherein the one or more processors are configured to acquire reward information indicating reward money from the device of the first user, and the at least one user is a user satisfying a condition regarding the reward money.

9. The electronic device of claim 1, wherein the assignment information further includes language information indicating a language of source code to be written, and the specific source code is source code written in the language indicated by the language information.

10. The electronic device of claim 1, wherein the assignment information further includes language information indicating a language of source code to be written, and the one or more processors are configured to acquire solution information including specific source code written in a language different from the language indicated by the language information from a device of a third user among the multiple users.

11. The electronic device of claim 1, wherein the one or more processors are configured to:
acquire private information required to solve the specific assignment from the device of the first user, and
transfer the private information to the device of the second user.

12. An electronic device comprising:
a communication circuit configured to communicate with at least one external device;
one or more processors; and
one or more memories configured to store instructions which, when executed by the one or more processors, cause the one or more processors to perform a calculation,
wherein the one or memories are configured to store at least one assignment-solution information pair including assignment information and at least one piece of solution information regarding the assignment information,
wherein the one or more processors are configured to:
acquire assignment information indicating a specific assignment requiring write of source code from a device of a first user,
determine solution information including specific source code wrote to solve the specific assignment, based on the at least one assignment-solution information pair stored in the memories, and
transfer the solution information to the device of the first user, and
wherein the assignment information includes at least one predetermined condition for validating whether or not the specific assignment is solved.

13. A method performed by an electronic device comprising a communication circuit configured to communicate with at least one external device, one or more processors, and one or more memories configured to store at least one instruction executed by the one or more processors, the method comprising:
acquiring assignment information indicating a specific assignment requiring write of source code from a device of a first user among multiple users;
matching the assignment information with a second user among the multiple users;
acquiring solution information including specific source code wrote to solve the specific assignment from a device of the second user; and
transferring the solution information to the device of the first user,
wherein the assignment information includes at least one predetermined condition for validating whether or not the specific assignment is solved.

14. The method of claim 13, wherein the specific source code is source code satisfying all of the at least one predetermined condition.

15. The method of claim 14, further comprising:
acquiring at least one source code from the device of the second user;
confirming, with regard to each of the at least one source code, whether or not all of the at least one predetermined condition is satisfied; and
determining the specific source code among the at least one source code based on the confirmation result.

16. The method of claim 13, further comprising transferring category information regarding the specific assignment to a device of at least one user among the multiple users.

17. The method of claim 13, wherein the matching the assignment information with the second user includes:
transferring the assignment information to a device of at least one user among the multiple users;
acquiring a user input that selects the assignment information from the device of the second user; and
matching the second user with the assignment information according to the user input.

18. The method of claim 13, wherein the assignment information further includes language information indicating a language of source code to be written, and the specific source code is source code written in the language indicated by the language information.

19. The method of claim 13, wherein the assignment information further includes language information indicating a language of source code to be written, and
wherein the method further comprises acquiring solution information including specific source code written in a language different from the language indicated by the language information from a device of a third user among the multiple users.

20. The method of claim 13, further comprising:
acquiring private information required to solve the specific assignment from the device of the first user; and
transferring the private information to the device of the second user.
